(19) United States
(12) Patent Application Publication
(10) Pub. No.: US 2019/0363380 A1
(43) Pub. Date: Nov. 28, 2019

(54) Device For The Air Supply Of A Fuel Cell

(71) Applicant: MAN Energy Solutions SE, Augsburg (DE)

(72) Inventors: Jan-Christoph Haag, Hirschberg (DE); Lutz Aurahs, Langweid (DE); Christoph Heinz, Langenau (DE); Klaus Bartholomä, Friedberg (DE)

(73) Assignee: MAN Energy Solutions SE

(21) Appl. No.: 16/420,915

(22) Filed: May 23, 2019

(30) Foreign Application Priority Data
May 24, 2018 (DE) DE102018112454.6

(51) Int. Cl. H01M 8/04111

(52) U.S. Cl. CPC H01M 8/04111

(57) ABSTRACT

A device for the air supply of a fuel cell operated with hydrogen, via a compressor of an exhaust gas turbocharger. The compressor is drive-effectively connected to a turbine of the turbocharger that can be driven by exhaust gas flow of the fuel cell via a shaft and also drive-effectively connected to a motor via a shaft. The compressor is connected to the fuel cell via an air supply duct for supplying compressed air.

### BACKGROUND OF THE INVENTION

### 1. Field of the Invention

The invention relates to a device for the air supply of a fuel cell, in particular of a fuel cell operated with hydrogen.

### 2. Description of the Related Art

Conventionally, fuel cells are operated with pure hydrogen, which reacts in the fuel cell to form water, releasing electricity in the process. Usually, the hydrogen for this purpose is expanded from a pressure vessel and fed to the fuel cell. The air that is necessary for the combustion in the fuel cell is drawn in from the surroundings by an electrically operated blower and fed to the fuel cell.

A generic prior art is described for example in DE 101 20 947 A1 or in DE 10 2004 051 359 A1.

In both publications, two compressor stages are provided and a conventional system bypass branches off after the second compressor stage and leads to the inlet of a turbine.

This configuration allows a certain regulation of the air supply but does not make possible the necessary degrees of freedom for example in order to prevent in various operating situations that with two compressor stages designed as flow compressors the desired flow rates and pressures in the region of the fuel cell can be adjusted in an energy-efficient manner.

In the automotive sector, fuel cells are known that are charged by turbochargers. There, the intake air is drawn in by the compressor of a turbocharger and the exhaust gas generated during the combustion drives the turbine of the turbocharger. If required, additional electric energy can be fed to the shaft of the turbocharger by an electric motor in order to offset a thermodynamic imbalance of the two components.

Disadvantageous with the known solutions is that these cannot be employed in an energy-efficient manner for energy generation on an industrial scale. There is a need for increasing the energy efficiency and thus the efficiency of the overall system.

### SUMMARY OF THE INVENTION

An object of the present invention therefore is to avoid the mentioned disadvantages and stating a setup which in terms of the flow rates and pressures supplied to the fuel cell offers a high degree of freedom with high energy efficiency at the same time.

A fundamental idea of one aspect of the invention is using a turbocharger, in particular an exhaust gas turbocharger for the air supply of a fuel cell and to operate the turbocharger in the performance equilibrium in that not only the energy that is utilisable by the exhaust gas flow is utilised for driving the compressor of the turbocharger, but the turbocharger can be additionally driven by a motor.

According to one aspect of the invention, a device for the air supply of a fuel cell operated with hydrogen via a compressor of an exhaust gas turbocharger is thus proposed, wherein the compressor is drive-effectively connected via a shaft to a turbine of the turbocharger that can be driven by an exhaust gas flow A of the fuel cell and the turbocharger, furthermore, is drive-effectively connected to a motor via a shaft, wherein the compressor is connected to the fuel cell via an air supply duct for supplying compressed air.

In a preferred configuration of the invention, the motor is an electric motor. It is advantageous, furthermore, when the motor, the compressor and the turbine are drive-effectively connected to one another on a common shaft, preferentially the shaft of the turbocharger.

In a further advantageous aspect of the invention it is provided that the motor is drive-effectively connected to the shaft of the turbocharger outside the turbocharger on the compressor side of the compressor.

Alternatively it can be provided that the motor outside the turbocharger on the turbine side is drive-effectively connected to the turbine with the shaft of the turbocharger. When the motor is thus connected outside the turbocharger, a sliding bearing that is usual with turbochargers can thus be employed, which compared with an oil-free mounting has significant advantages with regard to rotational speed and absorbing of axial forces. Provided this advantage is realised in the embodiment there is the possibility of designing the compressor and the turbine so as to be optimally efficient.

A further aspect of the present invention relates to the use of a device for providing air for a fuel cell as described above, which is part of a fuel cell system, via which electric drive power is provided for a consumer preferentially in the power range>100 kW.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Other advantageous further developments of the invention are marked in the subclaims or are shown in more detail by way of the figures together with the description of the preferred embodiment of the invention.

It shows:

FIG. 1 is a schematic diagram of a system for air supply of a fuel cell; and

FIG. 2 is a schematic diagram of system for air supply of a fuel cell.

### DETAILED DESCRIPTION OF THE PRESENTLY PREFERRED EMBODIMENTS

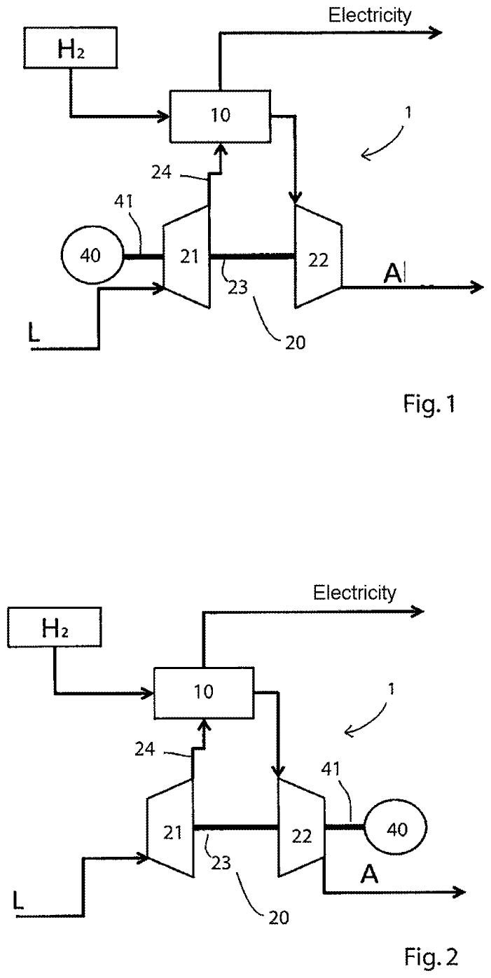

In the following, aspect of the invention are described in more detail by way of preferred exemplary embodiments with reference to the FIGS. 1 and 2, wherein the same reference numbers in the figures point to the same structural and/or functional features.

In the shown exemplary embodiments, a fuel cell 10 and the device 1 for the air supply of the fuel cell 10 operated with hydrogen is shown in each case. The device 1 comprises a compressor 21 and a turbocharger 20. The compressor 21 is drive-effectively connected to a turbine 22 of the turbocharger 20 that can be driven by an exhaust gas flow A of the fuel cell 10. The exhaust gas flow generated by the fuel cell 10 flows through the turbine 22 and, via the shaft 23, drives the compressor wheel of the compressor 21. In the process, the supply air for the fuel cell 10 is compressed by the compressor 21 and fed to the fuel cell 10 via the air supply duct 24.

In the exemplary embodiment according to FIG. 1, an electric motor 40 is provided, which can drive the compressor 21 via a driveshaft 23. For this purpose, the compressor wheel of the compressor 21 together with the turbine 22 is arranged on the common shaft 23, 41. Here, the motor is arranged outside the turbocharger 20 on the compressor side of the compressor 21.

In the exemplary embodiment according to FIG. 2 it is provided that the motor 40, outside the turbocharger 20 and specifically on the turbine side is drive-effectively connected to the turbine 22 with the shaft 23 of the turbocharger.

In both exemplary embodiments, the motor 40 is thus not arranged between the turbine 22 and the compressor 21, but in each case outside the turbocharger 20.

In its embodiment, the invention is not restricted to the preferred exemplary embodiments stated above. On the contrary, a number of versions is conceivable which makes use of the shown solution even with fundamentally different types of embodiments.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A device configured to supply air to a fuel cell, comprising:
an exhaust gas turbocharger having:
a turbine configured to be driven by an exhaust gas flow of the fuel cell;
a compressor of an exhaust gas turbocharger; and
a first shaft that drive-effectively connects the compressor to the turbine;
a second shaft;
a motor that is drive-effectively connected to the compressor via the second shaft; and
an air supply duct that connects the compressor to the fuel cell and configured to supply compressed air to the fuel cell.

2. The device according to claim 1, wherein the motor is an electric motor.

3. The device according to claim 1, wherein the motor, the compressor and the turbine are drive-effectively connected to one another on a common shaft comprising the first shaft and the second shaft.

4. The device according to claim 3, wherein the motor, outside the exhaust gas turbocharger arranged on a compressor side of the compressor, is drive-effectively connected to the first shaft of the exhaust gas turbocharger.

5. The device according to claim 3, wherein the motor, outside the exhaust gas turbocharger on a turbine side, is drive-effectively connected to the turbine with the first shaft of the exhaust gas turbocharger.

6. The device according to claim 4, wherein the mounting of the first shaft is effected by sliding bearings.

7. The device according to claim 1, wherein the fuel cell is configured to provide electric drive power to a consumer.

8. The device according to claim 7, wherein the electric drive power is in a power range of >100 kW.

9. The device according to claim 1, wherein the fuel cell, is a fuel cell that is operated with hydrogen.

10. The device according to claim 5, wherein the mounting of the first shaft is effected by sliding bearings.
